(19) United States
(12) Patent Application Publication
(10) Pub. No.: US 2005/0074057 A1
(43) Pub. Date: Apr. 7, 2005

(54) System and method for modulation on demand in a computing device

(76) Inventors: Gordon Bremer, Clearwater, FL (US); Kurt E. Holmquist, Lutz, FL (US); Edward A. Thoenes, St. Petersburg, FL (US); William L. Betts, St. Petersburg, FL (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/926,827

(22) Filed: Aug. 26, 2004

Related U.S. Application Data
(63) Continuation-in-part of application No. 09/213,732, filed on Dec. 16, 1998, now abandoned.
Application No. 09/213,732 is a continuation-in-part of application No. 08/962,796, filed on Nov. 3, 1997, now Pat. No. 6,061,392.
(60) Provisional application No. 60/068,324, filed on Dec. 19, 1997.

(51) Int. Cl. H04L 5/16

(52) U.S. Cl. 375/222

(57) ABSTRACT

A system and method for modulation on demand in a computing device, such as a personal computer, allows a central processor located in a computing device to perform the processing necessary to accomplish data communications without the need for an external processor. The system and method uses a novel modulation and accomplishes that modulation on the processor of a general purpose computing device.

### CROSS-REFERENCE TO RELATED APPLICATIONS

This document is a continuation-in-part (CIP) of and claims priority to and the benefit of the filing date of copending and commonly assigned U.S. patent application Ser. No. 09/213,732, entitled SYSTEM AND METHOD FOR MODULATION ON DEMAND IN A COMPUTING DEVICE, filed Dec. 16, 1998, which is a continuation-in-part (CIP) of and claims priority to and the benefit of the filing date of copending and commonly assigned U.S. patent application Ser. No. 08/962,796, entitled APPARATUS AND METHOD FOR COMMUNICATING VOICE AND DATA BETWEEN A CUSTOMER PREMISES AND A CENTRAL OFFICE, filed Nov. 3, 1997; now U.S. Pat. No. 6,061,392 issued May 9, 2000, and claims priority to and the benefit of the filing date of copending and commonly assigned Provisional Application Ser. No. 60/068,324 entitled MODULATION ON DEMAND ON A PERSONAL COMPUTER, filed Dec. 19, 1997, which are all hereby incorporated by reference.

### TECHNICAL FIELD

The present invention relates generally to communication systems, and more particularly, to a system and method for modulation on demand in a computing device such as a personal computer.

### BACKGROUND OF THE INVENTION

Data communication between two devices is typically accomplished by the use of a modem or a transceiver located at each communication endpoint. Modern communication systems use many different technologies to perform this transfer of information from one location to another. Some examples are Digital Subscriber Loop (DSL), wireless local area networking, and broadband cable. These technologies encompass many varieties of modulation techniques, one of which is continuous, or full duplex, point-to-point operation.

Full duplex modulation requires the transmission and reception of continuous signal streams for the entire duration of the communication session. This continuous interaction occurs even though there may be idle periods during which no data is being communicated, so that the full resources required for modulation/demodulation functions are committed even though there may be no information being exchanged. This results in a waste of communication processor resources.

Typically transceivers are implemented as peripheral devices to which are connected various types of communication terminal equipment, for example, a personal computer (PC). The personal computer may be used for communication with other computers over the Internet. A prior art transceiver was usually implemented as an element separate from the PC's central processing unit (CPU). The transceiver cooperated with the personal computer to execute signal processing (including software code) which enabled the operation of the transceiver. In this manner, separate processors (one located on the transceiver and one located in the personal computer) were used to transfer data on the communication channel.

This multiple processor architecture was used because it was difficult to implement the full duplex, resource inefficient, communication scheme in a single processor located in a PC. Thus, a heretofore unaddressed need exists in the industry to address the aforementioned deficiencies and inadequacies.

### SUMMARY OF THE INVENTION

The present invention provides a system and method for modulation on demand in a computing device.

The system of the present invention uses the processing power available in modern processors, such as those contained within PCs to execute a processor-efficient multipoint modulation scheme. The processor-efficient modulation scheme does not require continuous transmission and reception, contains a header that includes a length of message signal, and operates in a multipoint architecture. These features aid in implementing the majority of transceiver communication processor functions on a PC processor.

Briefly described, in architecture, the system can be implemented as follows. A system for modulation on demand contained within a computing device comprises a processor located in a computing device. Connected to the computing device is an analog front end and a memory device. A system bus within the computing device connects the processor, the analog front end, and the memory device. The analog front end comprises logic configured to measure an intermessage period and logic configured to determine if a plurality of received samples that is received after the intermessage period will be processed. The intermessage period starts with signal energy absence on a communication channel and ends with signal energy presence on the communication channel. The determination whether or not to process the received samples is based on the intermessage period.

The present invention can also be viewed as providing a method for modulation on demand in a computing device. In this regard, the method can be broadly summarized by the following steps: receiving in a processor located in a computing device a message containing a poll signal, the message represented by a block of samples, saving the block of samples in a memory, determining in the computing device whether to respond immediately to the poll signal, delaying a response to the poll signal if the computing device is processing other functions, responding to the poll signal when the computing device is available, and recovering information contained within a received message, the information being other than the poll signal, when the computing device is available by processing the block of samples representing the message that was saved at the time the message was received. Alternatively, the response to the poll signal may be pre-calculated such that a response may be made without immediately calculating a complete response.

The present invention can also be viewed as providing a receiver of a signal containing modulated information wherein a portion of the received signal is demodulated in real time and the remainder is demodulated at a later time. The signal can utilize various communication channels such as DSL, terrestrial wireless, etc. The present invention can also be viewed as providing a transmitter of a signal containing modulated information wherein a transmission response to a received poll is created from a data stored in memory as a predetermined, pre-modulated signal.

The present invention has numerous advantages, a few of which are delineated hereafter as merely examples.

An advantage of the invention is that it allows a processor located in a computer system to perform all the communication processing tasks previously performed in an external processor by allowing transmitter and receiver functions to be delayed and scheduling according to availability of processor resources.

Another advantage of the invention is that it reduces the peripheral circuitry required for a personal computer to communicate over a communication channel.

Another advantage of the invention is that it is simple in design, user friendly, robust, reliable, and efficient in operation, and easily implemented for mass commercial production.

Other features and advantages of the present invention will become apparent to one with skill in the art upon examination of the following drawings and detailed description. It is intended that all such additional features and advantages be included herein within the scope of the present invention.

### BRIEF DESCRIPTION OF THE SEVERAL VIEWS OF THE DRAWINGS

The invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1A is a schematic view illustrating the communication system topography in which the present invention operates;

FIG. 1B is a timing diagram illustrating the polling protocol employed by the control transceiver and remote transceivers of FIG. 1A;

FIG. 2 is a schematic view illustrating a simplified computer in which the present invention resides;

FIG. 3 is a schematic view illustrating an alternative embodiment of the computer of FIG. 2;

FIG. 4 is a block diagram illustrating the analog front end circuitry of FIGS. 2 and 3;

FIG. 5 is a block diagram illustrating sample stream transfer control device of FIG. 4; and

FIGS. 6A and 6B collectively are a flow chart illustrating the operation of the present invention.

### DETAILED DESCRIPTION OF THE INVENTION

The system and method for modulation on demand in a computing device can be implemented in hardware, software, firmware, or a combination thereof. In the preferred embodiment(s), the system and method for modulation on demand in a computing device is implemented in software that is stored in a memory and that is executed by a suitable instruction execution system.

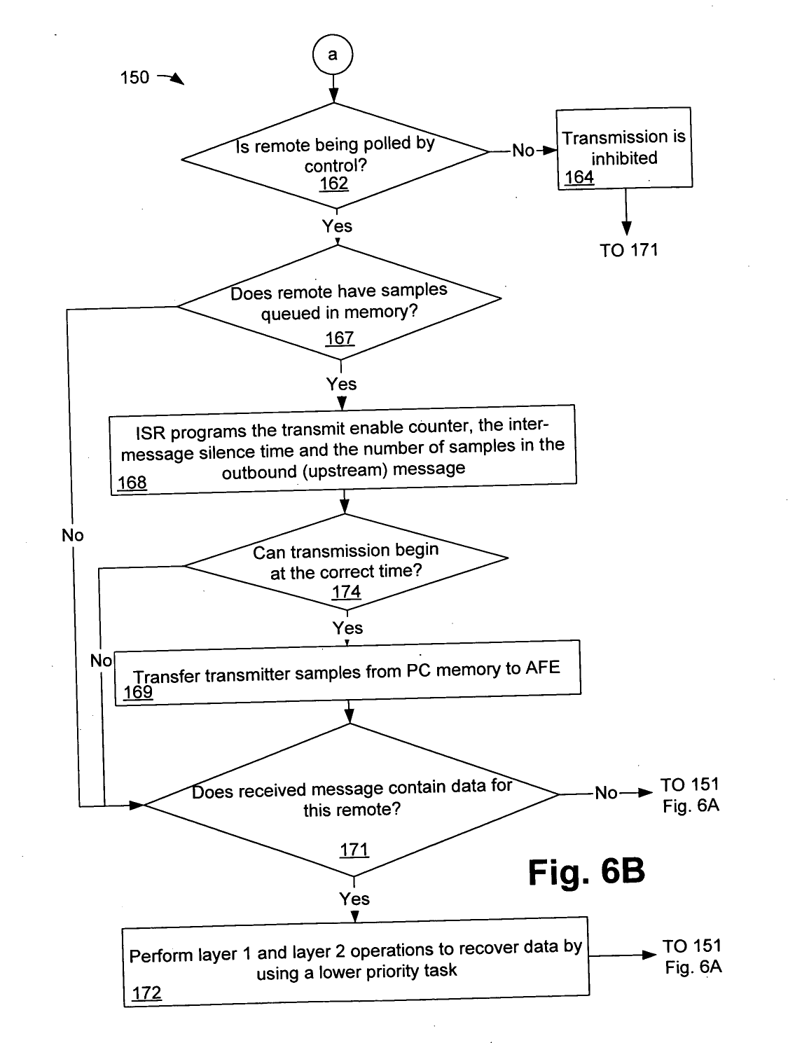

The flow chart of FIGS. 6A and 6B illustrate the functionality and operation of a possible implementation of the method for modulation on demand in a computing device. In this regard, each block represents a module, segment, or portion of code, which comprises one or more executable instructions for implementing the specified logical function(s). It should also be noted that in some alternative implementations, the functions noted in the blocks may occur out of the order noted in FIGS. 6A and 6B. For example, two blocks shown in succession in FIGS. 6A and 6B may in fact be executed substantially concurrently or the blocks may sometimes be executed in the reverse order, depending upon the functionality involved, as will be further clarified hereinbelow.

The system and method for modulation on demand in a computing device program, which comprises an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random access memory (RAM) (magnetic), a read-only memory (ROM) (magnetic), an erasable programmable read-only memory (EPROM or Flash memory) (magnetic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

Prior to discussing the present invention, a brief discussion regarding the Open Systems Interconnect (OSI) 7-layer model will be helpful as in the discussion to follow, the terms layer 1 and layer 2 will be used. In 1978, a framework of international standards for computer network architecture known as OSI (Open Systems Interconnect) was developed. The OSI reference model of network architecture consists of seven layers. From the lowest to the highest, the layers are: (1) the physical layer; (2) the datalink layer; (3) the network layer; (4) the transport layer; (5) the session layer; (6) the presentation layer; and (7) the application layer. Each layer uses the layer below it to provide a service to the layer above it. The lower layers are implemented by lower level protocols which define the electrical and physical standards, perform the byte ordering of the data, and govern the transmission, and error detection and correction of the bit stream. The higher layers are implemented by higher level protocols which deal with, inter alia, data formatting, terminal-to-computer dialogue, character sets, and sequencing of messages.

Layer 1, the physical layer, generally controls the direct host-to-host communication of the hardware on the end user's data terminal equipment (e.g., a modem connected to a PC).

Layer 2, the datalink layer, generally fragments the data to prepare it to be sent on the physical layer, receives acknowledgment frames, performs error checking, and re-transmits frames which have been incorrectly received.

Layer 3, the network layer, generally controls the routing of packets of data from the sender to the receiver via the datalink layer, and it is used by the transport layer. An example of the network layer is Internet Protocol (IP) which is the network layer for the TCP/IP protocol widely used on Ethernet networks. In contrast to the OSI seven-layer architecture, TCP/IP (Transmission Control Protocol over Internet Protocol) is a five-layer architecture which generally consists of the network layer and the transport layer protocols.

Layer 4, the transport layer, generally determines how the network layer should be used to provide a point-to-point, virtual, error-free connection so that the end point devices send and receive uncorrupted messages in the correct order. This layer establishes and dissolves connections between hosts. It is used by the session layer. TCP is an example of the transport layer.

Layer 5, the session layer, uses the transport layer and is used by the presentation layer. The session layer establishes a connection between processes on different hosts. It handles the creation of sessions between hosts as well as security issues.

Layer 6, the presentation layer, attempts to minimize the noticeability of differences between hosts and performs functions such as text compression, and format and code conversion.

Layer 7, the application layer, is used by the presentation layer to provide the user with a localized representation of data which is independent of the format used on the network. The application layer is concerned with the user's view of the network and generally deals with resource allocation, network transparency and problem partitioning.

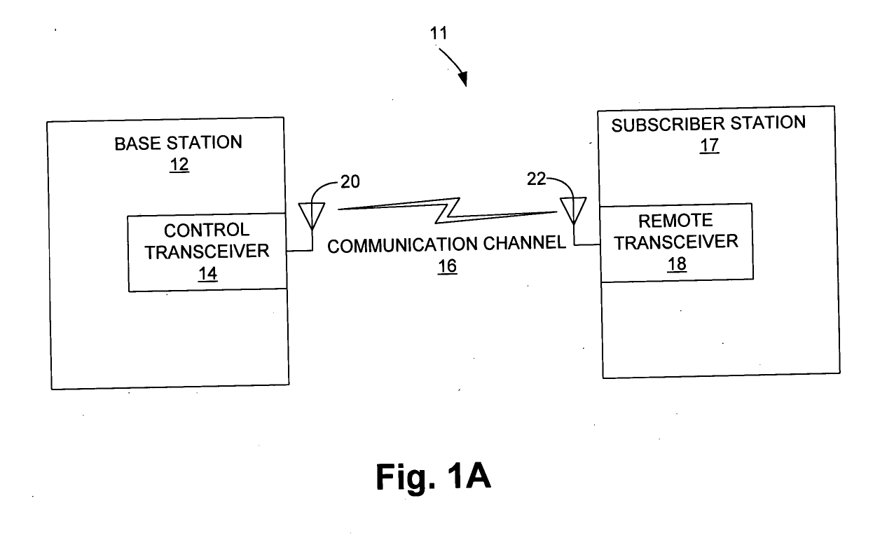

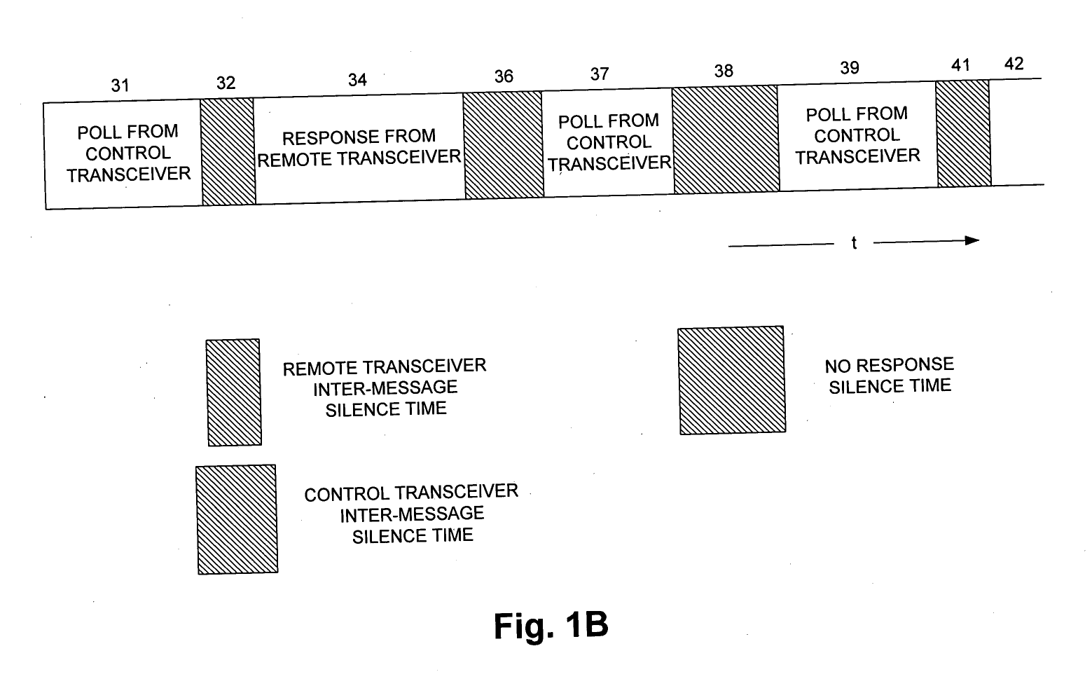

FIG. 1A is a diagram of the communication system in which the present invention operates. Communications system 11 includes base station 12 and at least one subscriber station 17 connected via communication channel 16. Base station 12 and subscriber station 17 communicate over the channel 16 using transceivers 14 and 18. The transceiver located at the base station is a control transceiver 14 and a transceiver located at a subscriber station 17 is a remote transceiver 18. Although only one remote transceiver is shown in this diagram, the control transceiver 14 may communicate with more than one remote transceiver 18. The system is thus a multipoint system, supporting either one-to-one or one-to-many.

In one embodiment, communication channel 16 is a wireless channel (e.g., one using the IEEE 802.11 standard), and the two transceivers 14 and 18 are radio frequency (RF) transceivers. In another embodiment, communication channel 16 is a broadbrand cable channel (e.g., one using IEEE 802.14). In yet another embodiment, communication channel 16 is a DSL subscriber loop.

FIG. 1B is a timing diagram illustrating the polling protocol employed by the control transceiver and remote transceivers of FIG. 1A. The horizontal axis labeled “t” in FIG. 1B indicates increasing time in the direction of the arrow. For ease of illustration, the timing diagram shows the times during which silence is present on communication channel 16 as shaded boxes.

Control transceiver 14 designates which, if any, of the remote transceivers 18 may transmit at a given time by sending a “poll” message that is addressed specifically to a particular remote. A “poll” is simply an invitation for that remote transceiver to transmit. Poll messages may optionally contain message information data, but it is not necessary for the remote transceiver to process the data portion of the message in order to properly respond to a poll. Furthermore, remote transceivers 18 receive only from the control transceiver 14 and can therefore ignore transmissions from other remote transceivers 18 that may be connected to the same communication channel 16. This feature of the modulation scheme is disclosed in commonly assigned co-pending U.S. patent application Ser. No. 08/980,996 entitled METHOD AND APPARATUS FOR PERFORMING A MULTIPOINT POLLING PROTOCOL WHICH EMPLOYS SILENCE INTERVALS FOR CONTROLLING CIRCUIT OPERATION, filed Dec. 1, 1997, now U.S. Pat. No. 6,414,964, issued on Jul. 2, 2002, which is hereby incorporated by reference.

The above operation can be considered “half-duplex” in that only one station transmits at a time. Furthermore, in this example embodiment, control transceiver 14 and remote transceivers 18 share the same physical medium (e.g., same frequency), and the physical layer is half-duplex. That is, only one transceiver transmits at a time: either control transceiver 14 or any one remote transceiver 18 (as selected by the control transceiver). However, an alternative embodiment is full-duplex at the physical layer (e.g. different frequencies are used), while remaining half-duplex at layer(s) above the physical layer.

In this alternative embodiment, a remote transceiver A can transmit to the control transceiver at the same time that the control transceiver is transmitting to a different remote transceiver B (allowable because physical layer is full-duplex). However, when remote transceiver A is transmitting to the control transceiver, the control transceiver does not transmit to remote transceiver A (half-duplex above physical layer).

The polling protocol link layer uses a short header with its own check field. This allows any transceiver on communication channel 16 to process header information before the entire message has been received, and determine whether it is being polled before the end of a message, which may contain data as well as a poll. The header also contains a field which indicates the length of the entire message, allowing a station to determine when a transmission will end well in advance of receiving the actual end of the transmission.

In the example shown in FIG. 1B, a polling message 31 is issued by the control transceiver 14. The polling message 31 is then followed by the maximum poll response delay 32, which is a longer interval of post-transmission silence than the interval following any remote transceiver transmission. Next, polled remote transceiver 18 transmits poll response 34. Following response 34, control transceiver 14 imposes a brief silence interval 36 before beginning to transmit another poll message 37. As illustrated, the length of silence interval 36 that precedes transmission by the control transceiver is longer than the silence interval that precedes the response from the remote transceiver. This difference in the length of silence intervals indicates whether control transceiver 14 transmits next. As all transceivers connected to the line can measure the length of this silence interval, they all know whether the control transceiver or a remote transceiver will begin transmitting next.

The polling message 37 is then followed by the no-data silent interval 38, indicating that the remote transceiver 18 which received the polling message had no real data to send to the control transceiver 14. The control transceiver 14 responds to silence interval 38 by sending polling message 39 which is addressed to a different remote transceiver 18. Polling message 39 is followed by a transmission of data 42 from the polled remote transceiver 18 to the control transceiver 14 after a brief silence interval 41 which is less than or equal to the maximum poll response delay. Alternatively, the polled remote transceiver 18 could respond with silence if it has no data to send.

The no-data silent interval is illustrated as being of shorter duration than the interval required for sending data or a polling message. This is intended to demonstrate that the no-data silent interval can be extremely short in duration, thereby minimizing the amount of bandwidth needed for poll responses. The ability to use a very short silent poll response is one of the important advantages of this polling protocol. However, it should be noted that it is not necessary for the no-data silent threshold interval to be shorter than the intervals required for sending a polling message and/or data.

It is, of course, possible that the reason the control transceiver 14 receives silence in response to a poll message sent to a remote transceiver 18 is that the remote transceiver 18 is, for some reason, unable to respond. For example, the remote transceiver 18 may have been taken off line or had its power turned off, or it may have lost synchronization with the signals sent by the control transceiver 14 and may require that the control transceiver 14 send special signals to regain synchronization. In the first case, the remote transceiver 18 should no longer be polled or should be polled at a much lower rate. The second case requires that the control transceiver 14 send special signaling sequences. It is therefore necessary for the control transceiver 14 to be able to distinguish between the case where a remote transceiver 18 does not respond because it has no data to send and the case where it is unable to respond. This can easily be accomplished through the use of a special polling message which requires that the remote transceiver 18 respond regardless of whether or not it has data to send.

In accordance with this embodiment, after receiving a predetermined number of silent responses in response to a predetermined number of sequential polls sent to a particular remote transceiver 18, the control transceiver 14 sends a “mandatory-response” poll. Upon receiving this message, the remote transceiver 18 either sends a normal data message, if it has data to send, or it sends a non-silent “no-data” message which can be the type of non-silent “no-data” response commonly used by protocols for typical polled multipoint circuits. If the control transceiver 14 receives no response to this poll, it treats this as an indication that the remote transceiver 18 is unable to respond and, therefore, takes appropriate action. Because the mandatory-response poll is sent infrequently, the infrequent transmission of no-data responses by tributary stations only causes a negligible loss in bandwidth efficiency.

The preceding discussion was intended to illustrate the feature of using silence as a valid response to a poll of the polling protocol employed by control transceiver 14 and remote transceiver 18 of FIG. 1A. This feature aids in the placement of the processing functions of remote transceiver 18 within a personal computer.

In this example embodiment, signal energy is transmitted intermittently on communication channel 16 only when message data or polls are being sent. Therefore, when a station is not transmitting or receiving data addressed to it, only minimal processing is done, to monitor the line for end of silence and to maintain timing synchronization. This feature also aids in the placement of the processing functions of remote transceiver 18 within a personal computer. Maintaining synchronization is eliminated in an alternative embodiment through additional signaling which permits recovery of timing at each transmission. In yet another embodiment, signal energy is present on communication channel 16 even when no polls or message data are being sent (e.g., carrier marks are sent).

It should also be noted that the relative durations of the polling messages, the silent delay interval created by the control transceiver 14, the no-data silent interval and the actual data, with respect to one another, are not necessarily accurately depicted in the timing diagram of FIG. 1B. Rather, the timing diagram is merely intended to demonstrate the concepts of the multipoint polling protocol employed by control transceiver 14 and remote transceiver 18.

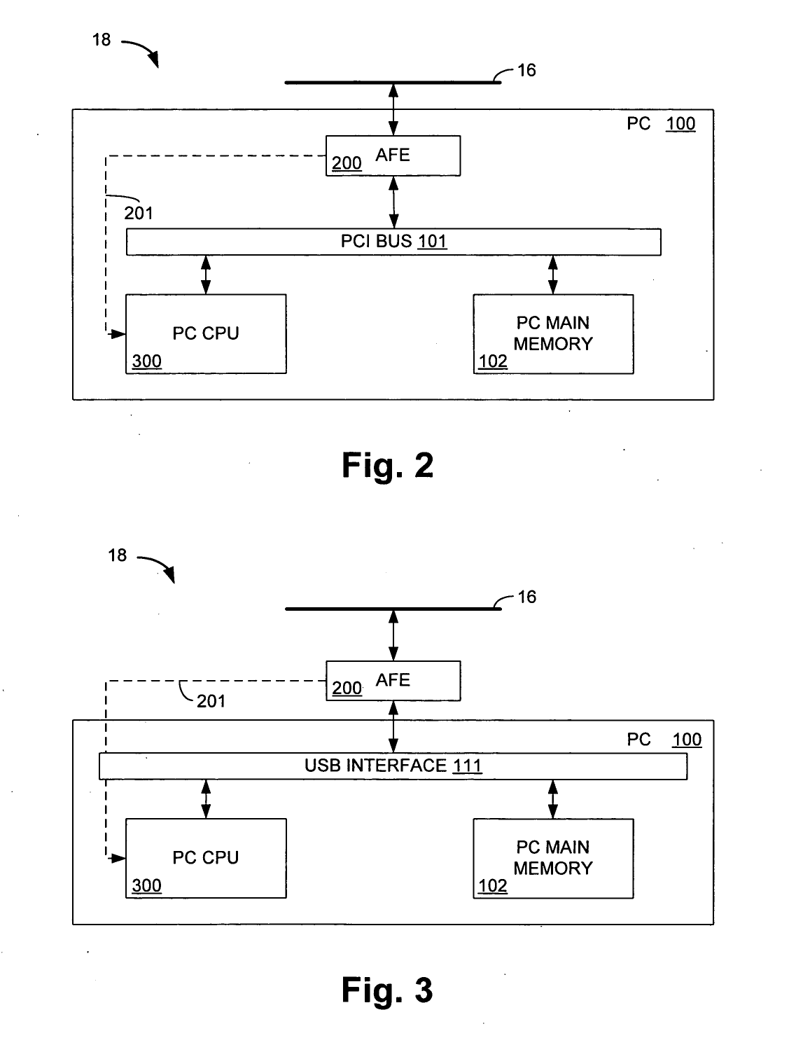

FIG. 2 is a schematic view illustrating a simplified personal computer (PC) 100 which implements the functionality of remote transceiver 18 of the present invention. Personal computer 100, implementing remote transceiver 18, is located at subscriber station 17 and is connected to communication channel 16. In the preferred embodiment, PC 100 also acts as a communication terminal device, transmitting and receiving data over communications channel 16 via remote transceiver 18. In an alternate embodiment, the communication terminal device is separate from PC 100 but is connected to PC 100 so that data can be transmitted and receiver over communications channel 16.

Personal computer (PC) 100 includes analog front end (AFE) 200, central processing unit (CPU) 300, and main memory 102, connected over peripheral component interconnect (PCI) bus 101. In accordance with the present invention, all of the communication processing tasks are performed by CPU 300, except for some simple functions performed by AFE 300. Among other functions, the AFE 300 determines whether signal energy is present on communication channel 16.

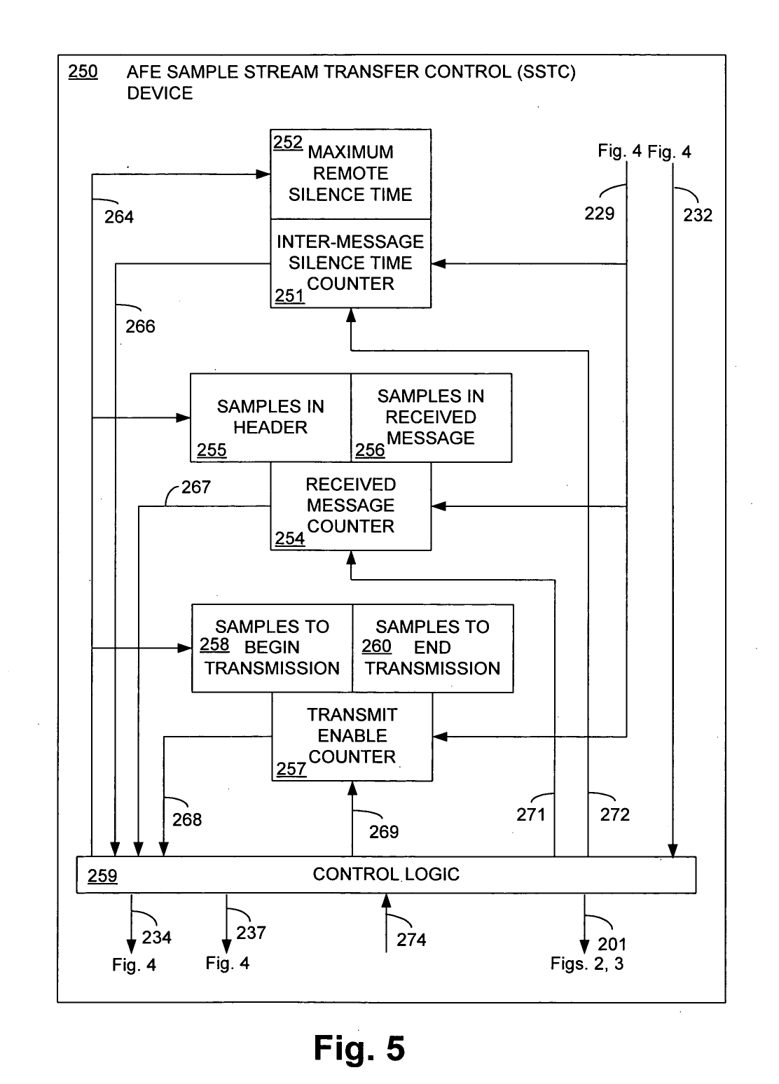

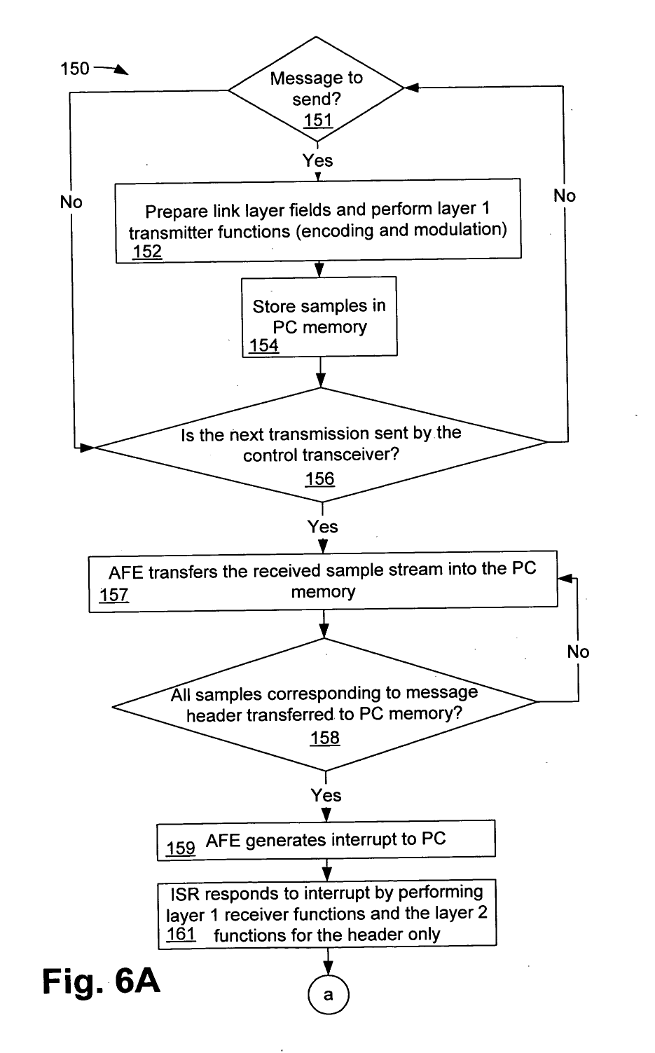

The polling protocol of communication system 11 allows most of the remote transceiver's functionality to be implemented by CPU 300. With this protocol, it is not necessary for a remote transceiver 18 to demodulate all received signals in real-time. Instead, a remote transceiver demodulates the header and uses the information inside to determine if the poll is addressed to this station. If not, no further demodulation is necessary. If so, and if the header indicates the poll also contains data, then the rest of the frame can be demodulated by the processor at a later time. On the transmit side, CPU 300 can use a low priority task to convert transmit data to a finite length block of samples which is then transferred to AFE 200 once the remote transceiver has been polled. The transfer of AFE samples to and from main memory 102 is accomplished via the PCI bus 101 using direct memory access (DMA) and will be described in further detail with reference to FIGS. 4 and 5. DMA will be appreciated by those skilled in the art.

These features significantly relax the real-time response requirements for CPU 300, significantly reduce the overall processing load on CPU 300, and significantly reduce the likelihood that intermittent delays in CPU 300 in executing communications functions (due to impending higher priority tasks) will result in failure or impaired operation of the communications circuit.

Typically, this communication processing on CPU 300 is performed by a module known as a “device driver.” The driver includes an interrupt service routine (ISR) which responds to interrupts generated by AFE 200 and by a DMA controller. Analog front end 200 provides an interrupt signal over connection 201 to CPU 300 and also determines when signal energy is present on communication channel 16, and will be described in detail with reference to FIGS. 4 and 5.

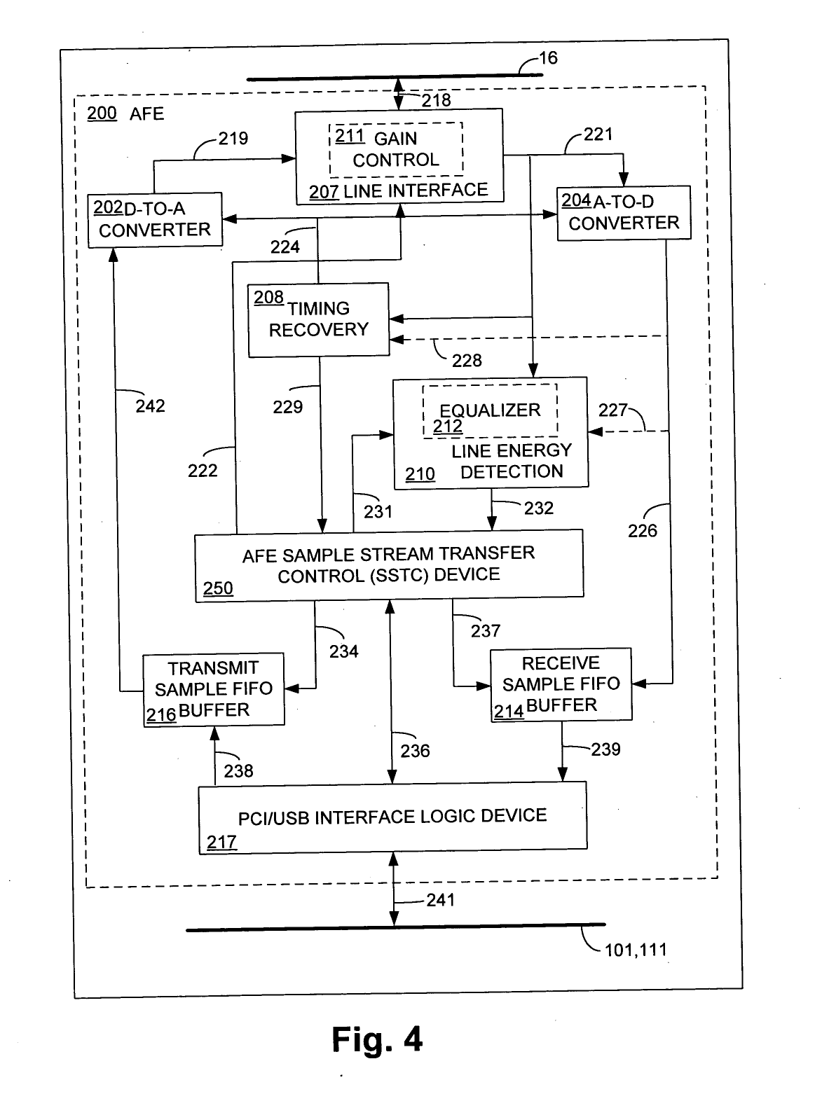

FIG. 3 is a schematic view illustrating an alternative embodiment of the computer of FIG. 2. As can be seen, PC 100 still resides within remote location 17, however, analog front end 200 is, in this embodiment, a separate function removed from PC 100 and connected to central processor 300 and main memory 102 over universal serial bus (USB) 111.

Analog front end 200 connects to communication channel 16 in a fashion similar to that described with reference to FIG. 2. In the embodiment shown in FIG. 3, analog front end 200 can be visualized as a separate hardware element, possibly in the form of a plug-in module, or a separate peripheral device that connects PC 100 to communication channel 16. Interrupt signal 201 is still provided from analog front end 200 to personal computer central processor 300 via the USB 111. (The path for the interrupt shown in FIG. 3 is only logically separate from other signals traversing the USB. The ability to convey an interrupt signal from a peripheral device to the CPU is an standard capability provided by the USB.). In both embodiments shown in FIGS. 2 and 3, the personal computer central processor 300 performs all of the signal processing in that there is no processor in analog front end 200. Furthermore, with respect to both FIGS. 2 and 3, it is assumed that PC 100 will respond to interrupt signal 201 generated by analog front end 200 with a reasonable latency relative to the maximum remote inter-message silence interval.

FIG. 4 is a block diagram illustrating the analog front end circuitry of FIGS. 2 and 3. Line interface 207 connects analog front end 200 to communication channel 16 over connection 218. Digital-to-analog (D-to-A) converter 202 provides transmit samples over connection 219 to line interface 207. Line interface 207 provides an analog receive signal over connection 221 to analog-to-digital (A-to-D) converter 204. A-to-D converter 204 converts the analog receive signal to a digital sample stream and provides its output over connection 226. The strength of the signal reaching the line interface 207 via communication channel 16 can vary over a wide range due primarily to a wide variation in the lengths of subscriber lines and the specific types of wire used. Therefore, as is standard practice, line interface 207 optionally also includes a variable gain component 211 that amplifies the received signal as needed to make use of the full range of the A-to-D converter 204.

Timing recovery block 208 generates a clock signal with a frequency equal to the sample rate of the transceiver and which is locked to the master timing reference source in the transmitter of control transceiver 14. This locking is performed via the aforementioned pilot tone, which is transmitted by the control transceiver 14 to all remote transceivers 18 over communication channel 16. The timing can be recovered directly from the received analog signal from line interface 207 over connection 221 or it can be recovered using the sample stream generated by A-to-D converter 204 over connection 226, which is supplied to timing recovery block 208 over connection 228. Timing recovery block 208 supplies an output on line 224 to both D-to-A converter 202 and A-to-D converter 204 in order to synchronize both devices to control transceiver 14. Timing recovery block 208 also provides the clock signal with a frequency equal to the sample rate over connection 229 to sample stream transfer control (SSTC) device 250.

Line energy detection block 210 detects the presence or absence (silence) of the switched-carrier transmission signal using either the analog signal directly from line interface 207 over connection 221 or via the received sample stream on line 226 supplied to line energy detection block 210 over connection 227. Line energy detection block 210 detects the beginning and end of a silence period which delimits all transmissions on communication channel 16. Line energy detection block 210 also detects the beginning of the phase of operation known as “startup” or training during which the transceivers connected to the line are conditioned to properly demodulate received signals. This can be done by detection of a very long period of silence and/or detection of one or more tones that precede the signal used for receiver conditioning. Optionally, line energy detection block 210 can also incorporate one or more filters (commonly referred to as an “equalizer” 212) to partially or fully compensate for the linear impairments imposed by the communication channel and thus enabling more accurate detection of the presence or absence of the line signal when these impairments are severe. The states of the aforementioned line signals are supplied from line energy detection block 210 to SSTC device 250 over connection 232.

Receive sample first in first out (FIFO) buffer 214 and transmit sample FIFO buffer 216 are placed between bus interface logic device 217 and A-to-D converter 204 and D-to-A converter 202, respectively. FIFO buffers 214 and 216 match the burst transfer rates required on the PCI or USB bus with the continuous rates required by the D-to-A converter 202 and A-to-D converter 204. The FIFO buffers 214 and 216 also allow the personal computer some latency in responding to direct memory access requests. Receive sample FIFO buffer 214 receives its transfer enable command over connection 237 from SSTC device 250 and provides received samples via connection 239 to interface logic device 217. Similarly, transmit sample FIFO buffer 216 receives its enable transfer command from SSTC device 250 over connection 234 and receives its sample stream from interface logic device 217 over connection 238. Receive sample FIFO buffer 214 receives the sample stream over connection 226 from A-to-D converter 204 and transmit sample FIFO buffer 217 provides the transmit stream to D-to-A converter 202 over connection 242. Interface logic device 217 communicates via connection 241 with either PCI bus 101 (FIG. 2) or USB interface 111 (FIG. 3) depending upon the configuration employed.

The sample stream transfer control device 250 primarily manages the transfer of transmitter and receiver samples between the analog front end 200 and personal computer 100. When the remote device in which AFE 200 resides is not actively transmitting, the SSTC device 250 causes line interface 207, or possibly the D-to-A converter 202, to send silence on communication channel 16 via connection 222. SSTC device 250 also generates the interrupt signals 201 (FIGS. 2 and 3) to the personal computer based on time intervals measured relative to the beginning and end of inter-message silence times and uses the recovered sample clock supplied by timing recovery device 208 over connection 229 as a time base.

Interface logic device 217, which is used for either PCI bus 101 or USB interface 111, allows analog front end 200 to transfer sample streams across the bus to and from the personal computer's main memory 102 (FIGS. 2 and 3) using direct memory access. Direct memory access (DMA), is a technique that those skilled in the art will appreciate. These transfers are done without any continuous participation by PC central processor 300. SSTC device 250 also allows the personal computer central processor 300 to access the sample stream transfer control device to set termination counts for counters, etc.

FIG. 5 is a block diagram illustrating the sample stream transfer control device 250 of FIG. 4. SSTC device 250 primarily includes inter-message silence time counter 251, received message counter 254, and transmit enable counter 257. All three counters are clocked by the recovered sample timing via signal 229. Inter-message silence time counter 251 measures the length of inter-message silence periods. The device driver executing on PC 300 programs the end count for this counter with the number of samples corresponding to the maximum remote transceiver inter-message silence time. When the maximum remote transceiver silence time 252 is reached it is known that the next transmission will be from control transceiver 14. In this case, control logic 259 enables the transfer of receiver samples to the personal computer main memory 102 when the current silence period ends (i.e., when energy is detected). Receive sample FIFO buffer 214 (FIG. 4) is enabled by control logic 259 over connection 237. SSTC 250 reloads the counter over connection 264 and resets the counter over connection 272. Inter-message silence time counter 251 receives recovered sample timing clock signals over connection 229 from timing recovery block 208 (FIG. 4). The end of count signal is sent from inter-message silence time counter 251 to control logic 259 over connection 266.

Inter-message silence time counter 251 is reset and started any time the transition from signal present to silence is detected by line energy detector 210. When the transition from silence to signal present is detected by line energy detector 210, if the value in the inter-message silence counter 251 exceeds the maximum tributary silence time value in saved in register 252, the transmission is qualified as being sent from the control transceiver 14. In this case, the received message counter 254 is started and transfer of received samples to PC main memory via receive sample FIFO buffer 214 begins. If the value of the inter-message silence counter 251 does not exceed the maximum tributary, or remote transceiver, silence time 252, transfer of received samples to PC main memory is not enabled.

Received message counter 254 is associated with two registers, the samples in header count 255 and the samples in received message count 256. The termination count for received message counter 254 is initially set to the number of samples in the header of a received message contained in register 255. The header length is the same number of bits in all messages so the number of samples for the termination count can be determined from the transmitted data rate (based on bits per symbol and samples per symbol) used by the control transceiver 14. When the received message counter 254 expires, it sends a signal over connection 267 to control logic 259, which generates an interrupt to the personal computer PC 300 over connection 201. Control logic 259 then automatically resets counter 254 and sets the termination count for counter 254 to the number of samples corresponding to the maximum length of a received message (again, based on a fixed maximum number of bits and the current data rate) contained in register 256. The reset is accomplished over connection 271. When this count is reached, control logic 259 stops transferring received samples to the PC main memory 102 by deasserting the enable transfer signal on connection 237 to receive FIFO buffer 214 (FIG. 4). This limits the amount of data transferred to the PC main memory 102 even if the CPU is unable to immediately respond to the interrupt issued by AFE 200 when the complete header has been received.

When a remote transceiver has a message to send to the control transceiver, it performs the layer 2 and layer 1 processing required to produce the sample stream representing the entire message before any of these samples are actually transmitted. This processing can be done by CPU 300 at a lower priority level allowing higher priority functions to supersede it. The transceiver is not ready to transmit a message until such time that this processing has been completed for the entire message. This sample stream is stored in CPU main memory 102 while the transceiver waits for an opportunity to send it. Thus, when the remote transceiver determines that it has been polled by the control transceiver, it has only to initiate transfer of the stored set of samples to the AFE 200 via DMA. No other processing by CPU 300 is required to support message transmission in real-time.

The interrupt service routine (ISR), executed by CPU 300 in response to the interrupt issued by AFE 200 when the header has been received, performs the layer 1 and layer 2 processing required to recover the information in the header only. If the header indicates that the remote transceiver is being polled and the remote transceiver has prepared a sample stream for a message to transmit as described above, the remote transceiver enables transfer via DMA of the transmit message samples from CPU main memory 102 to the D-to-A converter 202 in AFE 200 by way of transmit sample FIFO buffer 216.

In order to maximize the data transmission efficiency, the maximum tributary silence time must be kept to a very short time interval (as this represents idle time on the line). In order for other stations to reliably recognize that a silence interval exists, the interval must be greater than some minimum. In order for other stations to discriminate transmission by a remote station from that of the control station, the silence interval must not exceed the maximum limit. Thus there is a very narrow window of time during which a remote transceiver must begin transmitting its response when it is polled. Transmit enable counter 257 controls the beginning and end of transmission of message samples, relieving the CPU 300 of this responsibility (since meeting very precise timing requirements is difficult on a PC CPU that is performing a number of different tasks.)

The transmit enable counter 257 is associated with two registers, the samples to begin transmission count 258 and the samples to end transmission count 260. Transmit enable counter 257 is reset and started when the beginning of a transmission from the control transceiver 14 is detected (based on the measured length of the silence interval). The two registers, 258 and 260 are set by the interrupt service routine (ISR) executing on CPU 300 when it intends to respond to a poll received from the control transceiver 14. The samples to begin transmission count 258 is set to a time equal to the number of samples corresponding to the length of the current received message (also specified in the header containing the poll to which this station is responding) plus the required minimum remote transceiver inter-message silence time. If so enabled by the host ISR, when this counter expires, the control logic 259 allows the line interface 207 (FIG. 4) to transmit a signal other than silence and initiates transfer of transmit samples from PC main memory 102 to D-to-A converter 202 over connection 242 (FIG. 4). When the host ISR loads the sample count to begin transmission, it also loads the count to the end of transmission into register 260. This is determined by the length of the message being transmitted and the transmitted data rate used by this station, which is then added to the value loaded into register 258. When a message is being transmitted and the counter reaches this value, transfer of samples from PC main memory 102 to the D-to-A converter 202 is stopped and silence is transmitted instead.

It may be that, because CPU 300 is being used for operations of higher priority than the transceiver device driver, the CPU is not able to respond to a poll message within the maximum time allowed. If the CPU recognizes that it cannot respond during this time, it simply refrains from transmission of any message. As discussed previously, the line protocol is designed to optionally accept silence as a valid response from a remote transceiver that does not have data to send. However, it may be difficult as well for the CPU to reliably determine the bounds of the relatively narrow time interval within which it may respond. In other words, it may initially appear to the CPU that the response time requirements can be met so the CPU attempts to begin transmission, but, due to processing delays, transmission is not enabled until the maximum silence time has expired. This would result in an erroneous late transmission that would likely collide with a transmission from the control station which has just concluded from the length of the silence interval that the remote station will not transmit.

To prevent this, at the time the device driver ISR loads the count value for the samples to begin transmission register 258, control logic 259 compares this value to the value of the transmit enable counter 257. If the transmit enable counter 257 is greater than the samples to begin transmission count 258, transmission is inhibited. This prevents erroneous transmission after the maximum time interval has expired without requiring the CPU to very accurately monitor and respond to the boundaries of this interval. The transceiver device driver determines that transmission has been inhibited due to late initiation by reading status information from the control logic block 259. It will then attempt to send this same message in response to a subsequent poll.

After a block of samples transmitted by the control transceiver has been received by the remote transceiver, if the demodulation and decoding of the header portion indicates that the transmission is addressed to this remote transceiver and that it contains message data, the message data portion of the sample block (following the header) may be processed some time later whenever the computing resources become available. It is also possible for a remote device to respond with a pre-calculated response, the purpose of which is to return a response to the poll without the need to immediately calculate a complete response.

The results of the aforementioned functions of detection of silence and training by line energy detection block 210 are supplied to control logic 259 over connection 232. Commands from PC 100 are supplied to control logic 259 over connection 274, while interrupts to PC 100 are supplied from control logic 259 over connection 201.

FIGS. 6A and 6B collectively illustrate the operation of the present invention. In block 151 it is determined whether a remote transceiver 18 has a message to send. If a remote transceiver 18 has a message to send, in block 152 it prepares the link layer fields of the message and device driver performs the layer 1 transmitter functions, including encoding and modulation. If not, operation proceeds to block 156. In block 154 the device driver stores the resulting block of samples in the PC's main memory 102. This processing can be done as a low priority task.

In block 156 it is determined whether or not the next transmission is from control transceiver 14 by measuring the length of the inter-message silence interval. If this is the case, operation proceeds to block 157. If not, operation returns to block 151.

In block 157 when control transceiver 14 begins transmitting a message, the AFE 200 of remote transceiver 18 begins transferring the received sample stream into PC main memory 102.

In block 158 it is determined whether all samples corresponding to the message header have been transferred to PC main memory 102. When all samples are transferred, AFE 200 generates an interrupt signal over connection 201 (FIGS. 2 and 3) to PC central processor 300. The ISR responding to this interrupt performs the layer 1 receiver functions (equalization, demodulation, decoding, etc.) and the layer 2 functions for the header only. Since the header is very short and the control transceiver modulation is fairly simple, this processing can be done in a short time on a PC CPU or other processor with similar capabilities.

In block 162 it is determined whether the message from the control transceiver contains a poll of this remote transceiver 18. If not, then in block 164 transmission is inhibited and operation proceeds to block 171 where the remainder of the received message sample stream may be processed. If remote transceiver 18 is being polled by control transceiver 14, then it is determined in block 167 whether remote transceiver 18 has any samples queued in memory. If there are no samples queued in memory, then the operation proceeds to block 171. If remote transceiver 18 has a block of samples for an outgoing message queued in memory, then in block 168 the ISR programs the samples to begin transmission register 258 in SSTC 250 (FIG. 5) with a number of samples corresponding to the length of the received message (which is known from the header) plus the remote (tributary) inter-message silence time. The ISR also programs the samples to end of transmission register 260 with the value in register 258 plus the number of samples in the outbound message.

In block 174, control logic 259 determines whether or not transmission can begin within the required time interval by comparing the value in the transmit enable counter 257 to the time to begin transmission in register 258. If so, operation proceeds to block 169. Otherwise, operation proceeds to block 171.

In block 169, transmitter samples are transferred from personal computer main memory 102 (FIGS. 2 and 3) to transmit FIFO buffer 216 (FIG. 4). Transfer of transmitter samples from the PC's main memory to the AFE 200 is done automatically by the AFE hardware and the PC's direct memory access facility. This also terminates automatically based on the transmit message length count value loaded into the AFE by the ISR.

There are some instances when the remote transceiver 18 will receive a poll message from control transceiver 14 requiring remote transceiver 18 to respond with a message even if it has nothing to send. This is done periodically to determine whether or not remote transceiver 18 is still active. In this case, a predetermined no response message, which has already been converted to a block of samples in the background, can be transmitted. At this time, the ISR can also schedule preparation in the background of the next outbound (upstream) message.

In block 171 it is determined whether the received message from control transceiver 14 contains data for remote transceiver 18. If data is present, then in block 172, the layer 1 and the layer 2 operations required to recover this data from the received sample stream can be performed by a lower priority task and do not have to be done in the ISR.

Many variations and modifications may be made to the above-described embodiment(s) of the invention without departing substantially from the scope and principles of the invention. All such modifications and variations are intended to be included herein within the scope of the present invention.

1. A system for modulation on demand comprising:
a processor located in a computing device;
a memory device located on said computing device;
a system bus within said computing device connecting the processor and the memory device;
an analog front end connected to the system bus, the analog front end comprising:
logic configured to measure an intermessage period starting with signal energy absence on a communication channel and ending with signal energy presence on the communication channel; and
logic configured to determine, based on the intermessage period, if a plurality of received samples that is received after the intermessage period will be processed.

2. The system of claim 1, wherein the analog front end further comprises logic configured to process the plurality of received samples that is received after the intermessage period if the intermessage period exceeds a predetermined maximum.

3. The system of claim 1, wherein the analog front end further comprises logic configured to transfer to the processor the plurality of received samples upon a first condition, the first condition comprising the measured intermessage period exceeding a predetermined maximum and signal energy being detected after the measured intermessage period, where the transfer occurs over the system bus.

4. The system of claim 3, wherein the transfer uses Direct Memory Access (DMA).

5. A system for modulation on demand comprising:
a processor located in a computing device;
a memory device located on said computing device;
a system bus within said computing device connecting the processor and the memory device;
an analog front end connected to the system bus, the analog front end comprising:
logic configured to measure an intermessage period starting with signal energy absence on a communication channel and ending with signal energy presence on the communication channel;
logic configured to determine a transmit time, the transmit time based on signal energy presence detected after the intermessage period exceeds a predetermined minimum, and based on a last received message length; and
logic configured to transmit, at the transmit time, a message comprising a plurality of transmit samples.

6. The system of claim 5, wherein the analog front end further comprises logic configured to transmit silence after the message has been transmitted.

7. The system of claim 5, wherein the analog front end further comprises logic configured to transfer from the processor the plurality of transmit samples, where the transfer occurs over the system bus.

8. The system of claim 7, wherein the transfer uses DMA.

9. A system for half duplex modulation on demand comprising:
a processor located in a computing device;
a memory device located on said computing device;
a system bus within said computing device connecting the processor and the memory device;
an analog front end connected to the system bus, the analog front end comprising:
an intermessage timer configured to start when no energy is detected on a communications channel and to expire at a maximum time allowed between received messages; and
logic configured to restart the intermessage timer when energy is detected on the communications channel, and further configured to enable, upon a first condition, a transfer of received samples to the processor, wherein the first condition comprises an expiration of the intermessage timer and detection of energy after the expiration.

10. The system of claim 9, wherein the transfer uses DMA.

11. The system of claim 9, wherein the intermessage timer is a countdown timer and the processor is configured to set the starting value of the intermessage timer.

12. The system of claim 9, further comprising an A/D converter with a sample rate, wherein the interval of the intermessage timer is based on the sample rate, and wherein the expiration of the intermessage timer is based on the number of samples in the maximum time allowed between received messages.

13. The system of claim 12, wherein the intermessage timer is a countdown timer and the processor is configured to set the starting value of the intermessage timer to the number of samples in the maximum time allowed between messages.

14. A system for half duplex modulation on demand comprising:
a processor located in a computing device;
a memory device located on said computing device;
a system bus within said computing device connecting the processor and the memory device;
an analog front end connected to the system bus, the analog front end comprising:
an intermessage timer configured to start when no energy is detected on a communications channel and to expire at a maximum time allowed between received messages, and defining an intermessage period; and
a poll detector configured to detect signal energy presence after the intermessage period exceeds a predetermined minimum.

15. The system of claim 14, the analog front end further comprising:
a transmit timer configured to start on the detection by the poll detector and to expire at a time based on a last received message length; and
logic configured to transmit, upon the transmit timer expiration, a message comprising a plurality of transmit samples.

16. The system of claim 15, wherein the transmit timer is a countdown timer and the processor is configured to set the starting value of the transmit timer.

17. The system of claim 15, the analog front end further comprising an A/D converter with a sample rate, wherein the interval of the transmit timer is based on the sample rate, and wherein the expiration of the transmit timer is based on the number of samples in a last received message.

18. The system of claim 17, wherein the transmit timer is a countdown timer and the processor is configured to set the starting value of the transmit timer to the number of samples in the last received message.

19. The system of claim 14, the analog front end further comprising:
a received header timer configured to start on the detection by the poll detector and to expire at a first time based on a fixed header size; and
logic configured to interrupt the processor upon the expiration at the first time.

20. The system of claim 19, wherein the received header timer is a countdown timer, the analog front end further comprising logic configured to set the starting value of the received header timer.

21. The system of claim 19, the analog front end further comprising an A/D converter with a sample rate, wherein the interval of the received header timer is based on the sample rate, and wherein the expiration of the received header timer is based on the number of samples in a header of fixed size.

22. The system of claim 21, wherein the received header timer is a countdown timer, and the analog front end further comprises logic configured to set the starting value of the received header timer to the number of samples in the header.

23. The system of claim 22, the analog front end further comprising logic configured, upon expiration of received header timer at the first time, to reset the received header timer to expire at a second time based on a fixed maximum message size, and to set the starting value of the receiver header timer to the number of samples in a message of a maximum fixed size.

24. A receiver of a signal containing modulated information wherein a portion of the received signal is demodulated in real time and the remainder is demodulated at a later times.

25. A transmitter of a signal containing modulated information wherein a transmission response to a received poll is created from a data stored in memory as a predetermined, pre-modulated signal.
